(19) United States
(12) Patent Application Publication
(10) Pub. No.: US 2008/0270101 A1
(43) Pub. Date: Oct. 30, 2008

(54) Building Finite State Machine Model

(76) Inventor: Marko Salmela, Oulu (FI)

Correspondence Address: BARNES & THORNBURG LLP, 750-17TH STREET NW, SUITE 900, WASHINGTON, DC, 20006-4675, US

(21) Appl. No.: 11/994,946

(22) PCT Filed: Jul. 11, 2006
(86) PCT No.: PCT/FI06/50331

§ 371 Date: Jan. 7, 2008

(30) Foreign Application Priority Data
Jul. 12, 2005 (FI) 20055408

(51) Int. Cl. G06F 17/50

(52) U.S. Cl. 703/17

(57) ABSTRACT

A solution for building a finite state machine model is provided. The solution comprises: displaying (300) on a display a state associated with at least one modelling component, the component comprising information about available triggering events, detecting (302) the state and a modelling component obtaining focus, searching (304) for possible outgoing state transitions and destination states related to the state with which the at least one modelling component is associated, displaying (306) the detected outgoing state transitions and destination states, receiving (308) selections of the state transitions and destination states, and adding (310) the selections to the model describing the finite state machine model.

### FIELD

The invention relates to building of a finite state machine model. Especially, the invention relates to finite state machines utilising modelling components comprising information about available triggering events.

### BACKGROUND

In designing technical systems, devices and software applications, it is essential that the operation and behaviour of the system can be specified and verified efficiently. A common approach is to build a model describing the operation of the system. When the behaviour of the system is state-dependent and/or event-driven, a finite state machine may be used to model the system.

For example, in developing software, a model of the software may be developed before the actual software is implemented. A model of a software application may be compared to a blueprint of a physical device. A model utilising a finite state machine may be used in designing, specifying, testing and verifying the operation and dynamic behaviour of software. A known approach is to utilise graphical and visual state machine models to represent state-dependent behaviour of software applications.

Currently, visual state machine editors are used to draw graphical state machine models, such as UML (Unified Modelling Language) state charts. There are several problems related to current visual state machine editors. The designer needs to manually lay out a state chart or a diagram. Editing, changing and maintaining the diagram is laborious and time-consuming. The designer needs to know, identify or find out possible state machine events and related state transitions between the states. Currently, an approach for checking and verifying a finite state machine model is to use a state transition table. The state transition table is usually a two-dimensional table, for example, where one axis is used to list all states and another axis to list all possible events. The cells in the table are used to define relationships between the events and the states. The manual creation and maintaining of state transition tables and manual checking of the completeness of the state machine based on state transition tables is error-prone and time-consuming.

### BRIEF DESCRIPTION OF THE INVENTION

An object of the invention is to provide an enhancing solution for creating a finite state machine model. According to an aspect of the invention, there is provided a method of building a finite state machine model, the method comprising: displaying on a display a state associated with at least one modelling component, the component comprising information about available triggering events, detecting the state and modelling component obtaining focus, searching for possible outgoing state transitions and destination states related to the state with which the at least one modelling component is associated, displaying the found outgoing state transitions and destination states, receiving selections of the state transitions and destination states, and adding the selections to the model describing the finite state machine model.

According to another aspect of the invention, there is provided an electronic device comprising a processor, a display, and input means operatively connected to each other, the processor being configured to create a finite state machine model using modelling components associated with states of the state machine, the component comprising information about available triggering events, the device being configured to display on the display a state associated with at least one modelling component, detect the state and modelling component obtaining focus, The device is further configured to search for possible outgoing state transitions and destination states related to the state with which the at least one modelling component is associated, display the found outgoing state transitions and destination states, receive with the input means selections of the state transitions and destination states, and add with the processor the selections to the model describing the finite state machine.

According to another aspect of the invention, there is provided a computer program product encoding a computer program of instructions for executing a computer process for building a finite state machine model, the process comprising: displaying on a display a state associated with at least one modelling component, the component comprising information about available triggering events, detecting the state and modelling component obtaining focus, searching for possible outgoing state transitions and destination states related to the state with which the at least one modelling component is associated, displaying the found outgoing state transitions and destination states, receiving selections of the state transitions and destination states, and adding the selections to the model describing the finite state machine.

According to yet another aspect of the invention, there is provided a computer program distribution medium readable by a computer and encoding a computer program of instructions for executing a computer process for building a finite state machine model, the process comprising: displaying on a display a state associated with at least one modelling component, the component comprising information about available triggering events, detecting the state and modelling component obtaining focus, searching for possible outgoing state transitions and destination states related to the state with which the at least one modelling component is associated, displaying the detected outgoing state transitions and destination states related to the state the modelling component is associated with, receiving selections of the state transitions and destination states, and adding the selections to the model describing the finite state machine.

The solution according to the invention provides several advantages. The solution enables fast development of state machines in a graphical modelling environment. In an embodiment of the invention, state transition tables are automatically created, maintained, and seamlessly and dynamically integrated to the tool that is used for creating state machine models. The state transition table may be automatically generated based on the meta-information available about possible events for each state. This enables predictive building of state machines and automatic checking and verification of completeness. When designing a state machine model, the tool is configured to find out available triggering events and propose transitions and destination states to be added to the state machine model on the basis of the events. Automatic checking may be performed for inclusion of defined states and transitions. Thus, the designer does not need to manually draw and lay out the state machine diagrams. Also, the proposed method helps the designer to find out all the possible transitions, and thus aids to reach the completeness of the state machine diagram.

Furthermore, the invention lowers the learning curve for designers when they start developing state machines based designs for unfamiliar target software environments.

The invention provides an automated method for finding out and proposing state transitions with destination states on the basis of meta-information about component events.

### LIST OF DRAWINGS

In the following, the invention will be described in greater detail with reference to the embodiments and the accompanying drawings, in which

FIG. 1 shows an example of a device in which embodiments of the invention can be applied,

FIGS. 2A, 2B and 2C illustrate an example of building a state machine model, and

FIGS. 3 and 4 illustrate embodiments of the invention with flowcharts.

### DESCRIPTION OF EMBODIMENTS

In general, a state machine is a model that stores the status of a modelled item at a given time and can operate on input to change the status and/or cause an action or output to take place for any given change. State machine models are used to develop and describe device or software application interactions and behaviour. Properties describing a state machine can be listed as follows. A state machine has an initial state. The state machine receives a set of possible input events. Thus, a state machine cannot receive unknown input. The state machine comprises a set of new states that may result from the input. The state machine further comprises a set of possible actions or output events that result from a new state. When an input event causes the state machine to move from a state to another state, a state transition occurs. It is possible to define a state transition function that maps states and inputs to states.

A state machine that has a limited number of possible states is called a finite state machine. A finite state machine consists of states and transitions between states. Input events may trigger state transitions. A finite state machine can be used both as a development tool for approaching and solving problems and as a formal way of describing and documenting a solution for later developers and system maintainers.

A finite state machine may be designed using a visual state machine editor. The editor may provide libraries of modelling components that are used to model a target execution environment, e.g. an application execution environment for embedded application software. Examples of typical modelling components are graphical user interface (GUI) components and execution platform API (application programming interface) components. One or more modelling components may be associated with a state and each component may comprise information about available triggering events produced by the component. The information about possible triggering events is used to automatically propose appropriate state transitions and also their destination states.

In an embodiment, a modelling component may have a hierarchical structure. In such a case, the modelling component comprises a number of subcomponents. Each component in such a hierarchy may produce triggering events.

Modelling components may be designed using separate software tools. The information about the available triggering events may be included in the component in various ways, as one skilled in the art is aware. In an embodiment, the information may be stored in a separate data file. The data file can be created using XML (Extensible Markup Language), for example. The information may also be provided for a modelling component as another component which only contains the information. The information may also be included directly in the modelling component itself. The above-described embodiments are merely examples of the various ways to include or provide the information about the available triggering events in the modelling components.

A finite state machine may be graphically presented as a Unified Modelling Language state chart. UML (Unified Modelling Language) is a widely used language used to describe software models, for example.

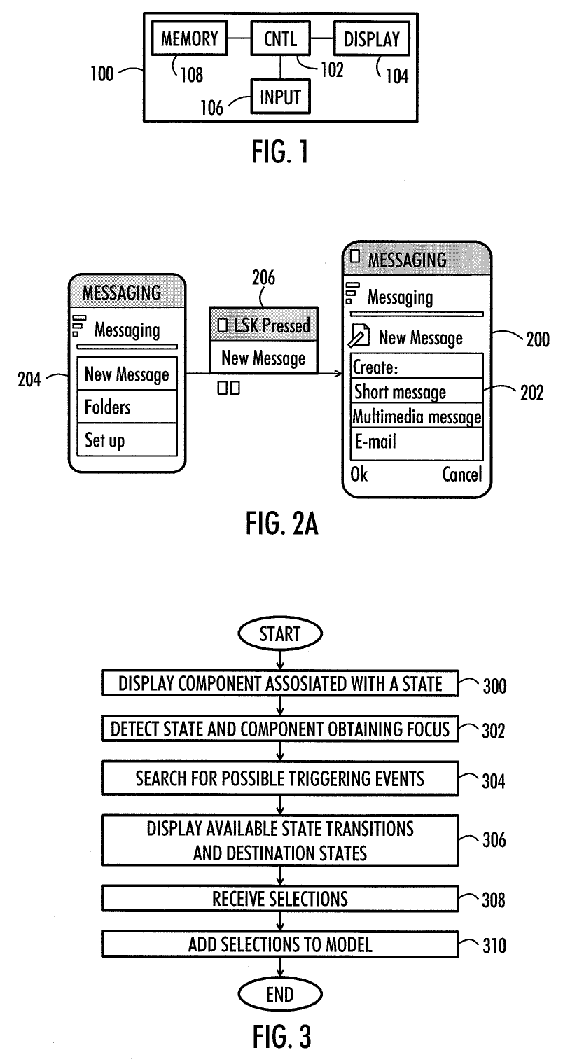

With reference to FIG. 1, examine an example of a device which may be used to build a state machine and in which embodiments of the invention can be applied.

The device 100 comprises a controller 102, a display 104, and input means 106 operatively connected to each other. The controller may be realised with a processor, integrated circuits and associated software, for example. The input means may comprise a keyboard, a keypad, a touch-sensitive screen, a pointer or a mouse, for example. In addition, the input means may comprise a communication interface, with which the device may be connected to another device. The input means may be any device or solution providing the user of the device with an interface to the device 100. The device 100 may also comprise a memory 108 which may be used to store data. The memory may be realised with one or more memory circuits, disc drives or with detachable memory devices such as memory cards, memory sticks, or diskettes.

The device 100 may be a personal computer, a laptop computer or any other device comprising the above-mentioned components. In an embodiment, the invention is realised with visual state machine editor software which is executed in the device 100.

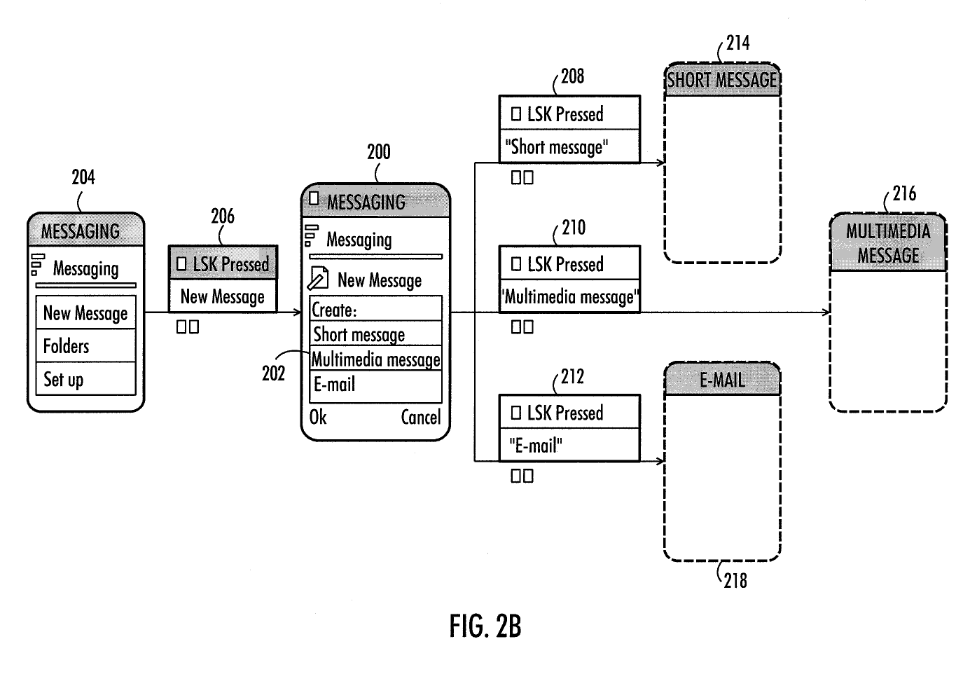

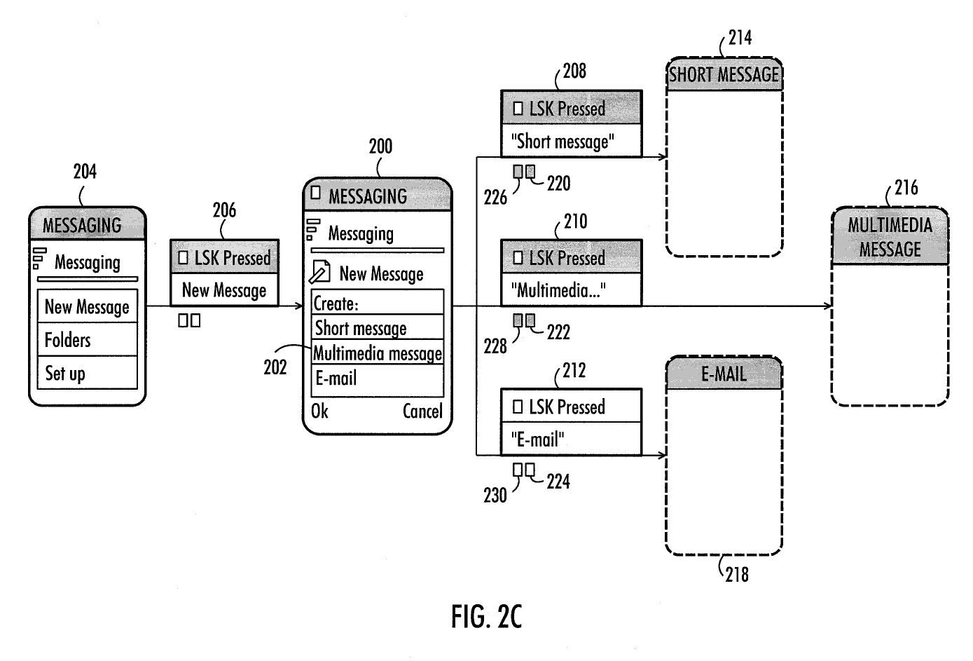

Let us study an embodiment of the invention with reference to FIGS. 2A, 2B, 2C and the flowchart of FIG. 3. In phase 300 of the flowchart of FIG. 3, a modelling component (in this example, a GUI view) associated with a state 200 of a finite state machine is displayed on the screen 102 of the device 100, as FIG. 2A illustrates. The example of FIG. 2A relates to a finite state machine describing the operation of a mobile telephone and the state 200 is representing a state of a messaging application where a new message command is selected. The state 200 comprises a GUI view of the messaging application of the mobile telephone. The associated GUI view comprises an Option Menu “Create” (which itself is a GUI subcomponent) that defines three list commands. These list commands represent potential event triggers for the outgoing transitions from the current state. In FIG. 2A, the Create menu (Option Menu) 202 is shown. The Create menu comprises three options: Short message, Multimedia message and E-mail. Other possible event triggers have been omitted from this example for the sake of clarity. Such potential triggering events may be provided by the currently visible graphical user interface (GUI) components, physical UI devices (keys or joystick), the application platform modules, I/O devices, and network services, for example.

In step 302, it is detected that the displayed state 200 and the modelling component associated with the state have obtained focus. A component obtains a focus when the user selects the component by clicking the component with a mouse or by other means well known in the art.

Also, one or more previous states 204 may be displayed on the display simultaneously with the current focus state 200. In an embodiment, the previous states are displayed smaller than the current focus state or greyed. The transition 206 from the previous state to the current state may also be shown.

In an embodiment, the two above steps are replaced by a step where the user adds a new state associated with a modelling component. The newly added state automatically obtains focus.

In step 304, possible triggering events are searched for. In an embodiment of the invention, the state transitions and destination states available for a component are displayed automatically on the display when the component obtains focus. In this case, when the component 200 obtains focus in step 302, it is checked whether the component has available outgoing state transitions and destination states. Three possible transitions are detected.

In step 306, the detected available outgoing state transitions and destination states are displayed on the screen 104 of the device 100, as FIG. 2B illustrates. The state 200 has in this example three possible state transitions 208, 210, 212 corresponding to the commands of the Create list 202: “Short Message”, “Multimedia Message” and “E-mail”. Each transition leads to a destination state 214, 216, 218 which is also displayed. The destination states may be displayed with a dashed outline so that the user may quickly determine that they are not a part of the state machine, yet.

Thus, the designer of the state machine can easily see the available choices when designing the state machine. State transitions and destination states for the transitions for each triggering event not yet part of the state machine are proposed visually for the designer. The proposed transitions may be visually categorized by the event types. The designer may select a displayed category from a list or by clicking a modelling component assigned to the focus state. In this embodiment of the invention, the user may simply select the transitions that are needed in the application under design by clicking the transition with a mouse, for example.

Thus, if a state has the focus, all transitions related to the state are shown. If a modelling component or a subcomponent has obtained the focus, only the transitions provided by the component or the subcomponent are shown.

The time-consuming manual layout design is thus eliminated. The designer does not need to manually draw neither the transitions nor the states, and the designer is not required to re-locate the graphical state machine elements manually. These manual editing and layout tasks are repetitive and time consuming in the prior art visual state machine editors. The designer may also modify the properties of the included transitions and destination states. The designer may change the assigned destination states from a list of previously defined states instead of including new states, for example.

In step 308, the user's selections are received. In this example the user selects the state transitions 208, 210 corresponding to the Create list 202 commands “Short Message” and “Multimedia Message”.

In step 310, these transitions and corresponding destination states are added to the state machine model. In an embodiment, the added transitions and destination states are displayed differently compared to the transitions and states that were not selected. As FIG. 2C illustrates, the unselected transition 212 and the destination state 218 are shown non-emphasised compared to the selected transitions 208, 210 and destination states 214, 216. Thus, the user may quickly determine which transitions and destination states currently belong to the state machine and which do not.

In an embodiment, the designer may review the finite state machine model under construction by shifting the focus from one state to another. When a state containing a modelling component is selected the modelling component is also considered to be selected by default. The events of the selected modelling component define the current event category that is displayed and is editable. If a focus state contains more than one modelling components, one of modelling components is selected by default according to the applied policy. For instance, the policy may be that the first modelling component is selected initially. Each time it is detected that a state and modelling component obtains focus, it is checked whether the component provides trigger events for state transitions and destination states which are not yet included in the finite state machine. The detected state transitions and destination states for unhandled trigger events are displayed on the display with a special visual indication as long as the modelling component has the focus. The designer can select any proposed state to be added to the state machine at any time. The designer can also view and edit the already included transitions and states normally. Thus, the user may easily modify the model. The designer may also be provided with an option to toggle either the proposed or the included transitions to be visually excluded from the display.

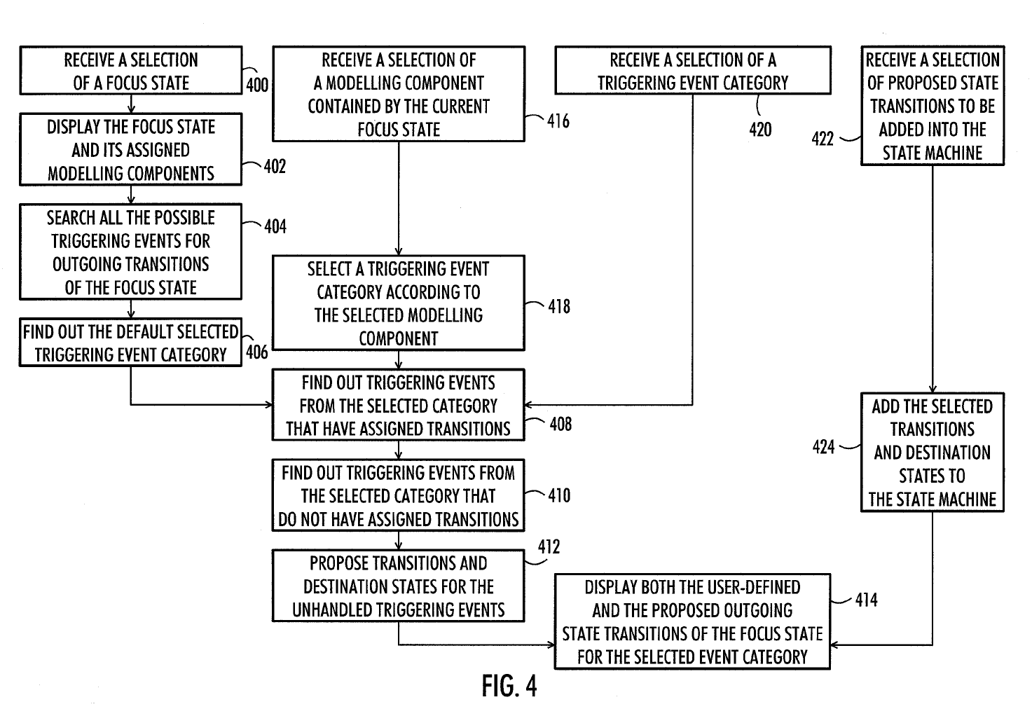

Let us study an embodiment of the invention with reference to the flowchart of FIG. 4. In step 400, a selection of a focus state is received. The designer may select any state from available states of the current visual state machine model. The selected state is set to be the current focus state. The designer may also add a new state into the state machine diagram, in which case it is automatically set to be the current focus state.

In step 402, the focus state and modelling components associated with the state are displayed. A state can have one or more associated modelling components. Each modelling component may be hierarchical. In such a case, it is composed of a number of subcomponents.

In step 404, all the possible triggering events for outgoing transitions of the focus state are searched for. The possible triggering events are gathered from all the modelling components (including their possible subcomponents) and from the context of the focus state. The context of a state is an execution context of the state machine that can be, for instance, embedded software and its execution platform. A software execution platform may define a number of possible events that an application and its state machine may receive as triggering events.

In step 406, the default selected triggering events category is searched for. Usually, it is not practical to display all proposed state transitions for all possible triggering events simultaneously. Therefore, the triggering events and their assigned transitions may be categorized. Categorization can be based on the event types or on source modelling components.

In step 408, triggering events from the selected category and having assigned transitions are searched for. Some of the events may already have been assigned to outgoing state transitions of the focus state. This means that the state machine specifies how the assigned events are handled if they occur when the focus state is the current state.

In step 410, triggering events from the selected category and having transitions that have not yet been assigned are searched for. In this step, the triggering events that are not yet assigned to outgoing transitions are found. These events may represent unhandled events for the focus state. All unhandled events may cause incorrect or incomplete behaviour or functionality for the implemented state machine. For instance, the modelled software system may receive a critical event that should be handled in order to guarantee correct behaviour. If the state machine model does not specify the handling for the received event the state machine fails to react on the received event and does not perform the required controlling actions.

In step 412, transitions and destination states for the unhandled triggering events are proposed.

In step 414, both the user-defined and the proposed state transitions of the focus state for the selected event category are displayed. The proposed new outgoing transitions are visually represented for the designer. A proposed destination state may be initially empty and the user can assign one or more modelling components to it by selecting the components from a component palette or list. In an embodiment, a set of rules may be applied in proposing a destination state. For instance, if a selected trigger event stands for a “Back” command, the destination state can be the parent state of the current focus state. The designer can also replace a proposed empty destination state with any state that already exists in the state machine. However, in some cases some restrictions need to be made to maintain state machine correctness. From the proposed state transitions the user can select the ones that are included into the state machine (step 422).

Another branch of the flowchart of FIG. 4 begins with step 416. In step 416, a selection of a modelling component contained by the current focus state is received. A modelling component assigned to a state may have a hierarchical structure. Thus, it may comprise a number of subcomponents. For instance, a state may have an assigned GUI view that can contain any number of GUI components. Each of the contained GUI components is considered as a modelling component that may define a number of triggering events. The designer may select any top-level modelling component assigned to a focus state, and any subcomponent of a top-level component.

In step 418, a triggering event category according to the selected modelling component is selected. The current event category is set to be the set of outgoing events defined by the selected modelling components. The process may continue from step 408.

Another branch of the flowchart of FIG. 4 begins with step 420. In step 420, a selection of a triggering event category is received. Besides selecting an event component by selecting a modelling component, the designer may also select an event category from a provided list or panel. The process may continue from step 408.

Another branch of the flowchart of FIG. 4 begins with step 422. In step 422, a selection of proposed state transitions to be added to the state machine is received. The designer can select the outgoing state transitions for the focus state from a set of proposed state transitions. In step 424, the selected transitions and destination states are added to the state machine. The user-selected transitions and the destinations states assigned to transitions are included into the state machine model. After the addition of the selected elements the displayed state machine diagram is updated in step 414.

In an embodiment, various indicators are shown along with the state transitions. In the example of FIG. 2C, the display comprises indicators 220, 222 and 224 which may be used as error indicators. These indicators may give the user a visual notification that the element or definition in question is not semantically correct. Elements and definitions with an error indicator cannot be executed in the simulation of the state machine. The display comprises indicators 226, 228 and 230 which may be used as warning indicators. The warning indicators may be used to indicate that an element or a definition is either not defined at all or something may be missing from the definition. Undefined elements (such as the E-mail transition in FIG. 2C) are excluded from this checking. Elements and definitions with a warning indicator are executable but they may be logically incorrect or incomplete from the execution point of view. A state machine is executable when it complies with the execution semantics defined for the applied state machine formalism. Execution can be realised through code generation by interpreting the state machine.

The embodiments of the invention may be realised in an electronic device comprising a display, a keyboard, and a controller operationally connected to the keyboard and the display, for example. The controller may be configured to perform at least some of the steps described in connection with the flowcharts of FIGS. 2 and 4 and in connection with FIGS. 2A, 2B and 2C. The embodiments may be implemented as a computer program comprising instructions for executing a computer process for building a finite state machine model, the process comprising: displaying on a display a state associated with at least one modelling component, the component comprising information about available triggering events, detecting the state and a modelling component obtaining focus, searching for possible outgoing state transitions and destination states related to the state the at least one modelling component is associated with, displaying the found outgoing state transitions and destination states, receiving selections of the state transitions and destination states, and adding the selections to the model describing the finite state machine.

The computer program may be stored on a computer program distribution medium readable by a computer or a processor. The computer program medium may be, for example but not limited to, an electric, magnetic, optical, infrared or semiconductor system, device or transmission medium and may include at least one of the following media: a computer-readable medium, a program storage medium, a record medium, a computer-readable memory, a random access memory, an erasable programmable read-only memory, a computer-readable software distribution package, a computer-readable signal, a computer-readable telecommunications signal, computer-readable printed matter, and a computer-readable compressed software package.

Even though the invention has been described above with reference to an example according to the accompanying drawings, it is clear that the invention is not restricted thereto but it can be modified in several ways within the scope of the appended claims.

1. A method of building a finite state machine model, the method comprising:
displaying (300) on a display a state associated with at least one modelling component, the component comprising information about available triggering events,
detecting (302) the state and modelling component obtaining focus,
characterized by
searching (304) for possible outgoing state transitions and destination states related to the state with which the at least one modelling component is associated,
displaying (306) the found outgoing state transitions and destination states,
receiving (308) selections of the state transitions and destination states, and
adding (310) the selections to the model describing the finite state machine model.

2. The method of claim 1, characterized by
detecting that a state and modelling component associated with the state obtains focus,
checking whether the component provides triggering events with available state transitions and destination states not included in the finite state machine,
displaying the detected state transitions and destination states on the display.

3. The method of claim 3, characterized by displaying the state transitions and destination states included in the finite state machine emphasised compared to state transitions and destination states which are not included in the finite state machine.

4. The method of claim 1, characterized in that the finite state model describes behaviour of the user interface of an electronic device.

5. The method of claim 1, characterized in that the model is a Unified Modelling Language state chart.

6. The method of claim 1, characterized in that indicators indicating an error or a warning are displayed along with states.

7. The method of claim 1, characterized in that a modelling component which is associated with a state comprises subcomponents.

8. The method of claim 1, characterized by a subcomponent comprising subcomponents.

9. The method of claim 7 or 8, characterized by a subcomponent providing triggering events with state transitions and destination states.

10. An electronic device comprising a processor (102), a display (104), and input means (106) operatively connected to each other, the processor (102) being configured to create a finite state machine model using modelling components associated with states of the state machine, the component comprising information about available triggering events, the device being configured to
display on the display (104) a state associated with at least one modelling component,
detect the state and modelling component obtaining focus,
characterized by the device being further configured to
search for possible outgoing state transitions and destination states related to the state with which the at least one modelling component is associated,
display the found outgoing state transitions and destination states,
receive with the input means (106) selections of the state transitions and destination states, and
add with the processor (102) the selections to the model describing the finite state machine.

11. The device of claim 10, characterized by the device being further configured to
detect that a state and modelling component associated with the state obtains focus,
check whether that the component provides triggering events with available state transitions and destination states not included in the finite state machine,
display the detected state transitions and destination states on the display (104).

12. The device of claim 10, characterized by the device being further configured to
display the state transitions and destination states included in the finite state machine emphasised compared to state transitions and destination states which are not included in the finite state machine.

13. The device of claim 10, characterized by the device being further configured to display indicators indicating an error or a warning along with states.

14. A computer program product encoding a computer program of instructions for executing a computer process for building a finite state machine model, the process comprising:
displaying (300) on a display a state associated with at least one modelling component, the component comprising information about available triggering events,
detecting (302) the state and modelling component obtaining focus,
characterized by the process further comprising: searching (304) for possible outgoing state transitions and destination states related to the state with which the at least one modelling component is associated,
displaying (306) the found outgoing state transitions and destination states,
receiving (308) selections of the state transitions and destination states, and
adding (310) the selections to the model describing the finite state machine.

15. A computer program distribution medium readable by a computer and encoding a computer program of instructions for executing a computer process for building a finite state machine model, the process comprising:
displaying (300) on a display a state associated with at least one modelling component, the component comprising information about available triggering events,
detecting (302) the state and modelling component obtaining focus,
characterized by the process further comprising:
searching (304) for possible outgoing state transitions and destination states related to the state with which the at least one modelling component is associated,
displaying (306) the detected outgoing state transitions and destination states related to the state the modelling component is associated with,
receiving (308) selections of the state transitions and destination states, and
adding (310) the selections to the model describing the finite state machine.

16. The computer program distribution medium of claim 15, the distribution medium including at least one of the following media: a computer-readable medium, a program storage medium, a record medium, a computer-readable memory, a computer-readable software distribution package, a computer-readable signal, a computer-readable telecommunications signal, and a computer-readable compressed software package.
